(19) United States
(12) Patent Application Publication
(10) Pub. No.: US 2004/0087881 A1
(43) Pub. Date: May 6, 2004

(54) Electrical heat and massage vibrating glove

(76) Inventor: Julia Gross, Memphis, TN (US)

Correspondence Address: Julia Gross, 2033 Warren Street, Memphis, TN, 38106, US

(21) Appl. No.: 10/128,669

(22) Filed: Nov. 2, 2002

(51) Int. Cl. A61H 23/02

(52) U.S. Cl. 601/15; 601/72

(57) ABSTRACT

The Electrical Heat And Vibrating Glove is a fully leather enclosed glove which combines the application of both gentle heat and gentle massage to give the wearer or user comforting sensations to facilitate a reduction in hand stiffness, joint pain and discomfort in the below-wrist area. Configured in left and right hand versions, the glove operates on electricity obtained from conventional wall sockets(heating element) and a 2-AA battery powered massage motor. Additionally, the glove has a portability feature in that the heating element can be alternately powered by a 16 volt transformer. The heat is manually regulated by a top-side heat control dial, and the strength of the massage sensation is governed by the 2-speed battery-powered massage motor. The glove is open at the fingertips so that redness and skin irritation is easily detectible; this also adds a sporty look to the glove.

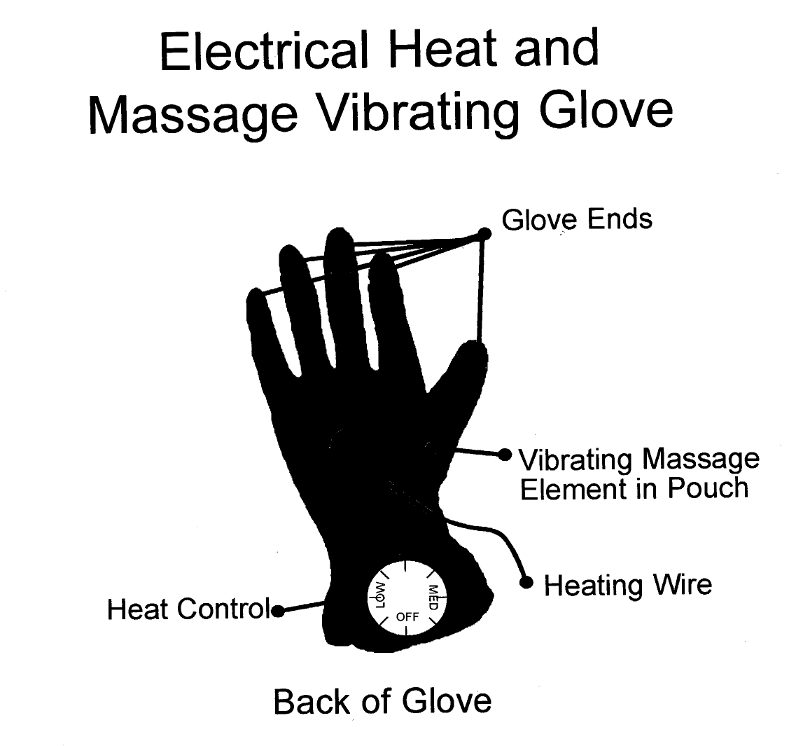

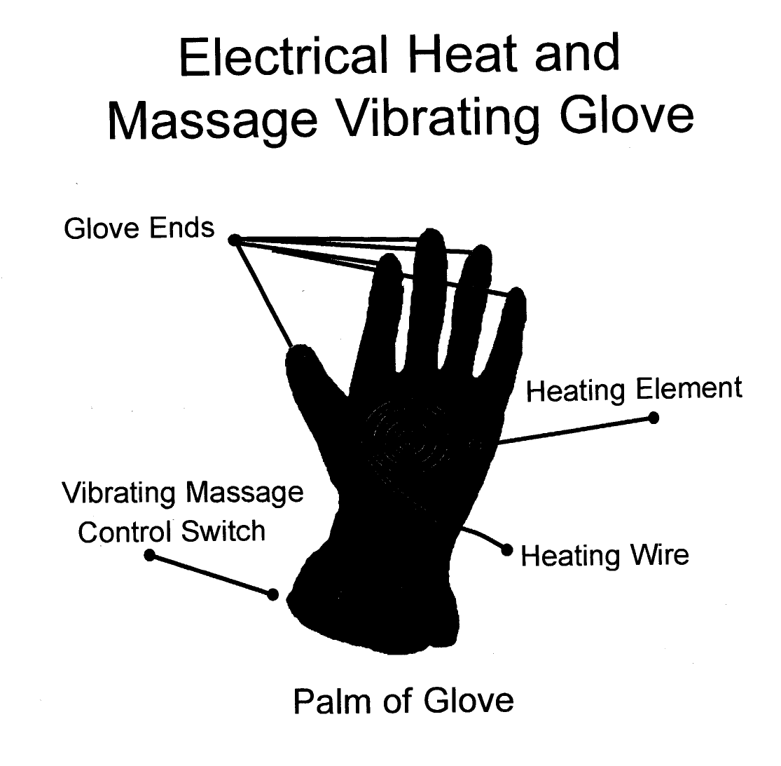

### CROSS REFERENCES TO RELATED APPLICATIONS

None

### STATEMENT AS TO RIGHTS TO INVENTIONS MADE UNDER FEDERALLY SPONSORED RESEARCH AND DEVELOPMENT

None

### BRIEF SUMMARY OF THE INVENTION

This invention is a self-contained leather glove with a battery(AA) powered two-speed massage motor and glass-enclosed heating element which is powered by electricity obtained from a standard wall socket outlet (or portably with a 16 volt transformer unit). The two-speed massage motor has control settings of “high”, “medium” and “low”. The combination of heat and gentle massage vibrations is of utility to sufferers of stiffness, pain and arthritic conditions in their hand and finger joints. The leather glove is made into multiple sizes for those with small, medium or large hands.

### BRIEF DESCRIPTION OF SEVERAL VIEWS OF DRAWING

The attached drawings illustrate the back and palm views of the glove. On the back(top of hand) side of the leather glove is vibrating massage element and the heat control dial. The massage element and the wire connecting it to the battery powered motor are both enclosed and sewn into the leather glove. The heat control dial simulates a watch in outward appearance. The palm view of the leather glove illustrates the sewn-in heating element and the wrist-area massage control setting. In both illustrations, the heating and vibrating massage elements are positioned in the glove's center so that the heat and vibrations will radiate evenly across the hand.

### DETAILED DESCRIPTION OF THE INVENTION

The Electrical Heat And Massage Vibrating Glove has the outward appearance of a standard lady's or man's glove—with two(2) notable exceptions. One, the glove is open at, and does not encapsulate, the fingertips and, two, the wrist of the glove contains a watch-appearing heat control unit on the top side and a palm side vibrating massage controller. The glove can be made in either right or left hand versions, and for small, medium or large hands.

The invention consists of a leather glove lined with heat retardant material. The palm side of the glove has a heating wire element which is enclosed in glass-insulated tape and is powered by conventional electricity from the wall socket outlet. For portability, the heating element may be alternately powered by a 16 volt transformer. The reverse (back) side of the glove contains, in the center, a vibrating massage element (which) is powered by two(2) AA batteries for 2-speed operation with a 3-position switch(Off, High & Low).

The palm side heating element and back side massage vibrating element are both centrally located for a radiating effect to the hand.

1. The Electrical Heat And Massage Vibrating Glove is a manufacture which synthesizes known processes and manufactures. The glove utilizes an electrical heating element and an AA battery-powered vibrating massage motor, both fully enclosed in leather, to give the wearer the combined stimulus of radiating, simultaneous heat and gentle massage effect to alleviate stiffness, swelling and pain in the hand.

2. The glove is lined with heat retardant material and has a palm-side, fully insulated heating element powered with electricity derived from either a conventional wall electrical outlet or, in its portable version, by a 16 volt transformer. The back(top) side of the glove has a vibrating massage element which is centrally located and powered by a 2-speed motor(2 AA batteries required). The wrist area of the glove has a manually operated heat control dial which resembles an ordinary watch on the glove's back (top) side; the palm side wrist area has a 3-position(Off, High & Low) switch which controls the massage motor. The glove, by increasing the leather surface, heating element's length and amount of heat retardant material, may be configured for large, medium and small hands(left or right hand versions).

3. So far as known to the applicant, the Electrical Heat And Massage Vibrating Glove is not contained in the prior art.
